(19) United States
(12) Patent Application Publication
(10) Pub. No.: US 2026/0366552 A1
(43) Pub. Date: Nov. 19, 2026

(54) CONNECTING SYSTEM FOR THE FRAMEWORK OF JIGS/FIXTURES

(71) Applicant: Harcourt Industrial, Inc., Madison Heights, MI (US)

(72) Inventors: Robert William Beardmore, Rochester Hills, MI (US); Bryce Sturgis, Madison Heights, MI (US)

(21) Appl. No.: 19/414,093

(22) Filed: Dec. 9, 2025

Related U.S. Application Data
(60) Provisional application No. 63/730,208, filed on Dec. 10, 2024.

(51) Int. Cl. F16B 7/04; F16B 7/18

(52) U.S. Cl. CPC F16B 7/0493; F16B 7/18

(57) ABSTRACT

The present invention generally relates to framework jigs and, more particularly to a connecting system for interconnecting the framework. The invention includes a connector for interconnecting members of a jig assembly that includes a bolt and a washer mounted underneath the head of the bolt. The washer includes two opposed discs with each of the discs having a central opening, interior faces, exterior surfaces, and sides. The exterior surfaces include a frictional surface that provides frictional engagement between the bolt head and, for example, a plate. The facing surfaces have ramps that interlock to prevent unintended loosening of the bolt. The ramps include an inclined surface that terminates at a locking wall or at a surface generally perpendicular to the facing surface. The ramps extend radially outward from the center opening of the discs and are spaced around the facing surfaces. The bolt of the present invention has a specially designed head with at least twelve side surfaces and an increased shoulder height compared to standard bolts.

### CROSS-REFERENCE TO RELATED APPLICATIONS

This application claims the benefit of U.S. Provisional Application Ser. No. 63/730,208, filed Dec. 10, 2024, which is incorporated herein by reference in its entirety.

### TECHNICAL FIELD

This invention generally relates to framework jigs and, more particularly to a connecting system for interconnecting the framework.

### BACKGROUND OF THE INVENTION

Frameworks for jigs and fixtures are typically welded together or bolted together with standard bolts and washers. For many applications, this is acceptable. In these applications, the bolts and bolted members are held together with friction. However, in some applications, there is a need to ensure that the bolts are not inadvertently or unintentionally loosened through vibration and use.

What is needed is a mechanical lock between the bolts and members being bolted. In addition, in some applications there is a need for a bolt to which greater torque can be applied.

### SUMMARY OF THE INVENTION

The present invention generally relates to framework jigs and, more particularly to a connecting system for interconnecting the framework. The invention includes a connector for interconnecting members of a jig assembly that includes a bolt having a head, shank, and threads, and a washer mounted underneath the head of the bolt. The washer includes two opposed discs with each of the discs having a central opening, interior faces, exterior surfaces, and sides.

The exterior surfaces include a frictional surface that provides frictional engagement between the bolt head and, for example, a plate. The facing surfaces have ramps that interlock to prevent unintended loosening of the bolt. The ramps include an inclined surface that terminates at a locking wall or at a surface generally perpendicular to the facing surface. The ramps extend radially outward from the center opening of the discs and are spaced around the facing surfaces.

In use, the ramps slide over one another until the locking walls are engaged. The ramps and the locking walls create a cam lock that prevents unintended loosening of the bolt to secure the bolt with tension rather than friction. When the bolt is tightened, the locking walls seat together, allowing movement only across the face of said ramps.

The bolt of the present invention has a head that is specially designed for this application. The bolt head has twelve or more surfaces or faces. The faces mate with a tool for torquing the bolts into place. The faces ensure proper engagement with the tool and reduce any issue of the heads being stripped. The faces are also designed to ensure that only the proper torque tool is used to prevent unintended loosening of bolt.

The head is also designed for optimal torquing with an increased shoulder height compared to standard bolts. Testing has found that this increased shoulder height provides optimal torquing capabilities.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of a framework or jig of the present invention.

FIG. 2 is an exploded perspective view of the connector of the present invention.

FIG. 3 is a partial perspective view of the washer and bolt head of the present invention.

FIG. 4 is a side view of the bolt.

FIG. 5 is a chart showing the performance of the present invention.

FIG. 6 is a perspective view of the connector of the present invention.

FIG. 7 is a perspective view of the connector of the present invention.

### DETAILED DESCRIPTION OF A PREFERRED EMBODIMENT

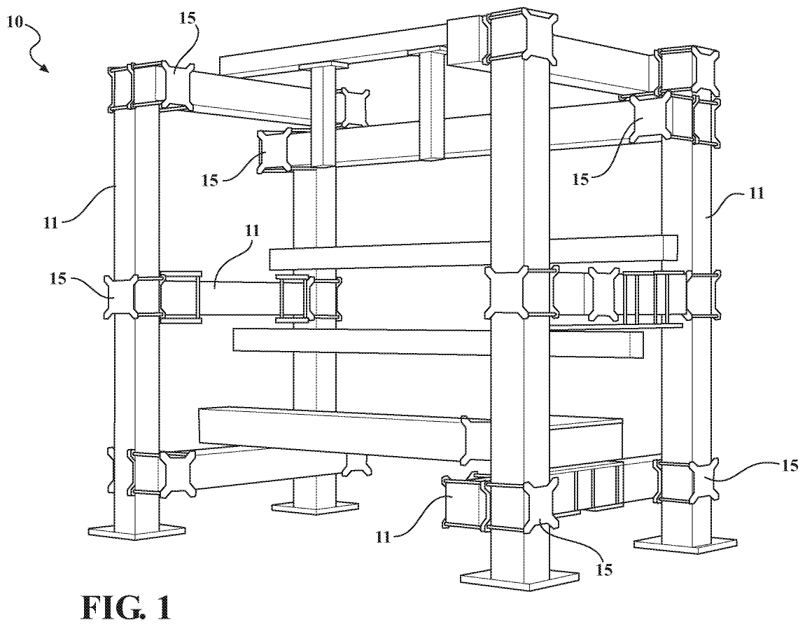

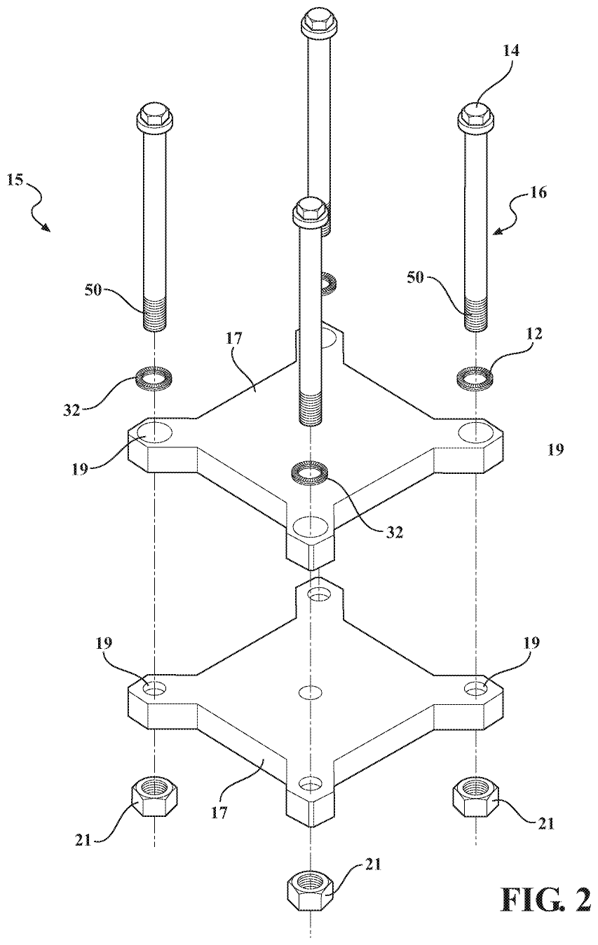

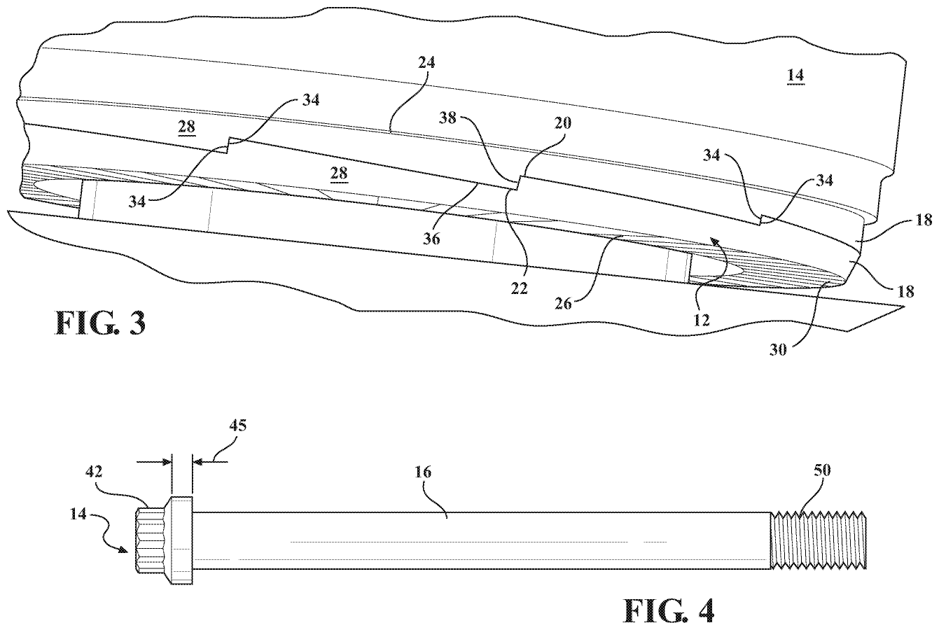

The present invention is for use in connecting the various components of a framework or jig generally shown at 10 in FIG. 1. The framework or jig 10 is made up of various members 11 that are connected by connector assemblies 15. As illustrated in FIG. 2, the connector assemblies 15 include plates 17 with openings 19 for receipt of bolts 16. Washers 12 are mounted underneath the heads 14 of the bolts 16. Each of the washers 12 has two opposed discs 18 with facing surfaces 20 and 22, exterior surfaces 24 and 26 and sides 28. The exterior surfaces 24 and 26 have grooves 30 extending radially outwardly from the center opening 32 of the washers 12. The grooves 30 provide frictional engagement between the bolt heads 14 and the plates 17. It should be understood by those of ordinary skill in the art that the invention is not limited to grooves 30, any type of frictional surface would work, such as for example, cross-hatched grooves, random indentations, or random raised bumps for example.

The facing surfaces 20,22 have ramps 34 that interlock to prevent unintended loosening of the bolts 16. The ramps 34 have an inclined surface 36 that terminates in a locking wall or surface 38 that is generally perpendicular to the facing surface 20, 22. The ramp angle is between about 4 to 6 degrees and preferably about 5 degrees. These ramps 34 as shown extend radially from the center opening 32 of washer 12 and are spaced around the surfaces 20,22. It should be appreciated by those of ordinary skill in the art, that fewer ramps 34 could be used and that the ramps 34 don't need to extend from the opening 32 to the sides 28. For example, the ramps 34 could be spaced between the center opening 32 and sides 28.

In operation, the washers 12 are placed on the bolts 16 through the central openings 32. The bolts 16 are then inserted through openings 19 and a nut 21 is attached to the threads 50 of the bolt 16. The bolts 16 are then torqued down to connect the members 11 together. The ramps 34 slide upon each other until the locking walls 38 engage. The ramps 34 and locking walls 38 create a cam lock that prevents unintended loosening of the bolts 16. These washers secure the bolts with tension rather than friction. When the bolt is tightened, the locking walls 38 seat together, allowing movement only across the face of the ramps 34.

The washers 12 make it nearly impossible for members 11 to become unintentionally disengaged or unintentionally loosened.

The bolt 16 has a head 14 specially designed for this application. The bolt head 14 has sixteen surfaces or faces 42. It could, if desired, have twelve or fourteen faces. The bolt 16 is made from a special stainless-steel material, HTS-80. The faces 42 mate with a tool for torquing the bolts 16 into place. The faces 42 ensure proper engagement and reduce any issue of stripping the heads 14. The faces 42 are also designed to ensure that only the proper torquing tool is used to prevent unintended loosening of the bolts 16.

The head 14 is designed for optimal torquing with an increased shoulder height 45 compared to standard bolts. Testing has found that this increased shoulder height provides optimal torquing capabilities. The shoulder height is about 5/16 inches in the disclosed embodiment.

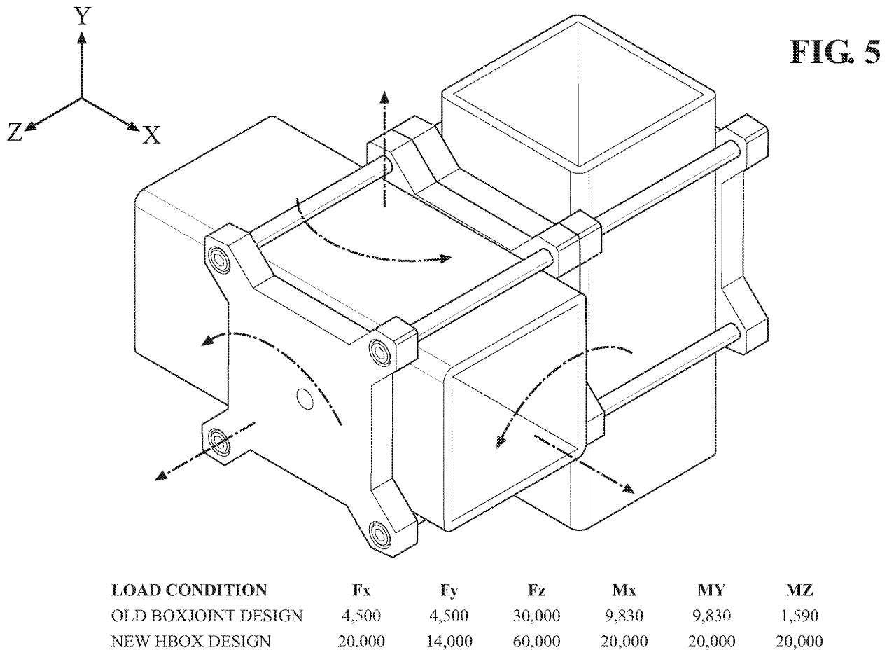

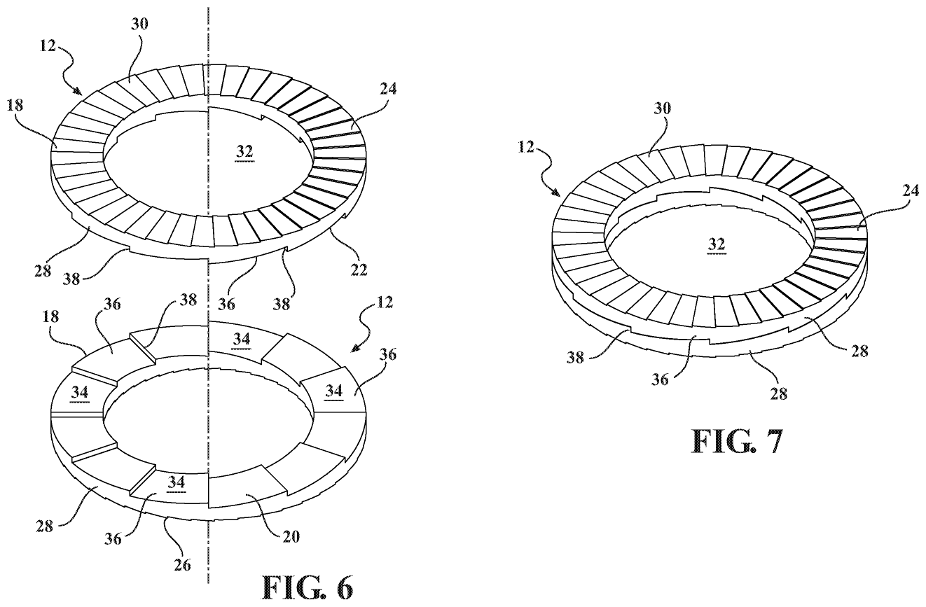

Testing shows that the present bolt 12 design and washer provide about 2 to 3 times the clamping strength over the previous traditional socket head style screws, see FIG. 5.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A connector for interconnecting members of a jig assembly, comprising:
a bolt having a head, shank, and threads;
a washer mounted underneath the head of said bolt, said washer includes two opposed discs with each of said discs having a central opening, interior faces, exterior surfaces and sides;
said exterior surfaces include a frictional surface providing frictional engagement between said bolt head and said jig assembly;
said facing surfaces have ramps that interlock to prevent unintended loosening of said bolt, said ramps include an inclined surface that terminates in a locking wall is generally perpendicular to said facing surface; said ramps extend radially outwardly from said center opening of said discs and are spaced around said facing surfaces;
whereby said ramps slide over one another until said locking walls engage, said ramps and said locking walls create a cam lock that prevents unintended loosening of said bolt to secure said bolt with tension rather than friction, so that when the bolt is tightened, said locking walls seat together, allowing movement only across said face of each of said ramps.

2. The connector of claim 1, wherein said frictional surface includes grooves extending radially outward from said center openings of said discs.

3. The connector of claim 1, wherein said grooves begin at said center opening of said discs and extend radially outward from said center openings of said discs.

4. The connector of claim 1, wherein said frictional surface includes grooves beginning at said center opening of said discs and extending radially outward from said center openings of said discs to said sides of said discs.

5. The connector of claim 1, wherein said jig assembly includes a plate and said frictional surface includes grooves extending radially outward from said center openings of said discs, said grooves are in frictional engagement between the bolt head and said plates.

6. The connector of claim 1, wherein said ramps extend from said opening to said sides.

7. The connector of claim 1, wherein said bolt head has at least twelve to sixteen side surfaces.

8. The connector of claim 7, wherein said side surfaces are configured to fit a tool for torquing the bolts, wherein said side surfaces ensure proper engagement with said tool to reduce stripping said heads, and only mate with said tool to prevent unintended loosening of said bolts.

9. The connector of claim 7, wherein said bolt is made from stainless-steel material HTS-80.

10. The connector of claim 1, wherein said bolt head has side surfaces which are higher than standard bolts to provide optimal torquing capabilities.
